(19) United States
(12) Patent Application Publication
(10) Pub. No.: US 2012/0160069 A1
(43) Pub. Date: Jun. 28, 2012

(54) MAGNETIC RECORDING MEDIUM AND PROCESS OF PRODUCING THE SAME

(75) Inventor: Tadashi ISHIGURO, Kanagawa (JP)

(73) Assignee: FUJIFILM CORPORATION, Tokyo (JP)

(21) Appl. No.: 13/410,568

(22) Filed: Mar. 2, 2012

Related U.S. Application Data
(62) Division of application No. 12/411,950, filed on Mar. 26, 2009.

(30) Foreign Application Priority Data
Mar. 27, 2008 (JP) 2008-084795
Jan. 23, 2009 (JP) 2009-012784

(51) Int. Cl. B26D 1/24

(52) U.S. Cl. 83/56

(57) ABSTRACT

A magnetic recording medium has a cut surface along an edge of the magnetic recording medium and includes, in the following order: a nonmagnetic support having a Young's modulus of 8 GPa or more in a width direction; a nonmagnetic layer formed by radiation curing a dispersion of a radiation curing compound and a nonmagnetic powder in a binder; and a magnetic layer containing a ferromagnetic powder dispersed in a binder, and the cut surface has a waviness of from 20% to 50% as defined herein.

### CROSS-REFERENCE TO RELATED APPLICATIONS

This is a divisional application of U.S. application Ser. No. 12/411,950, filed Mar. 26, 2009, which is hereby incorporated in its entirety by reference. This application claims the benefit of Japanese Patent Application JP 2008-084795, filed Mar. 27, 2008, and Japanese Patent Application JP 2009-012784, filed Jan. 23, 2009, the entire contents of which are hereby incorporated by reference, the same as if set forth at length.

### FIELD OF THE INVENTION

This invention relates to a magnetic recording medium, more particularly, a magnetic recording medium excellent in electromagnetic characteristics and cut edge quality and a process for producing the same.

### BACKGROUND OF THE INVENTION

A magnetic recording medium including a magnetic tape generally includes a nonmagnetic support and a magnetic layer provided on the support, the magnetic layer has a ferromagnetic powder dispersed in a binder. A magnetic tape is manufactured by preparing a magnetic coating composition from a ferromagnetic powder, additives, and an organic solvent, applying the composition to a nonmagnetic support and drying the coating layer to provide a continuous magnetic recording web, slitting the web using a slitter into strips of prescribed width, such as 8 mm, ½ inch, or 1 inch.

As illustrated in FIG. 4, a slitter 10 used to produce magnetic tapes is composed of vertical sets of a rotating upper blade 1 and a rotating lower blade 2. A magnetic web 3 is introduced between the upper blade 1 and the lower blade 2 and slit to width along the length to produce magnetic tapes 4.

The profile of an edge 4a (cut surface) of the magnetic tape 4 that appears on slitting the web 3 has increasing influences on the electromagnetic characteristics of the magnetic medium in association with the increasing recording density, decreasing thickness of magnetic recording media, and the increasing driving speed. The importance of cut surface profile control during slitting has thus been increasing. Specifically, it is required to control crack initiation on the edge of the magnetic layer and to control the unevenness on the cut surface 4a. If a crack generates in the magnetic layer, or if the unevenness of the cut surface 4a increases, the magnetic layer is scraped to produce dust and debris in long time use. The dust and debris attaches to the magnetic layer surface or gets into between a magnetic head and the magnetic layer, resulting in frequent occurrences of dropouts, write errors, read errors, and so forth.

In order to obtain a magnetic recording medium with excellent electromagnetic characteristics, it is known to form a radiation cured layer using a compound having a functional group curable by radiation, such as electron beam radiation, namely a radiation curing compound. The problem with a magnetic recording medium having such a radiation cured layer is that the cut surface 4a appearing on cutting a continuous web under conventional cutting conditions tends to have a poor surface profile, readily resulting in write errors, read errors, and the like due to, for example, magnetic head contamination.

Proposals contemplating to provide a magnetic recording medium with excellent electromagnetic characteristics include use of a radiation curing vinyl chloride polymer as a radiation curing binder resin in the backcoat layer as disclosed in JP 2001-84565A. A slitter configured to provide a good cut surface is proposed, e.g., in JP 2003-245890A, in which, when a magnetic web is introduced between a rotating vertical set of a lower blade and an upper blade to be cut, it is fed with its magnetic layer being in contact with the lower blade. JP 2007-257693A discloses a slitter having a rotating upper blade with a specific chamfer, with which a magnetic recording web including a support having a high Young's modulus in the CD can be slit with reduced crack generation and reduced unevenness on the slit surface thereby to produce highly reliable magnetic tapes.

### SUMMARY OF THE INVENTION

The invention disclosed in JP 2001-84565A contemplates to improve electromagnetic characteristics of a magnetic recording medium by using a radiation curing vinyl chloride polymer as a binder to form a backcoat layer on the back side of the nonmagnetic support (opposite to the magnetic recording layer). The disclosure of JP 2001-84565A is silent to the profile of the cut surface of the medium or slitting operation. The slitting methods and apparatus taught in JP 2003-245890A and JP 2007-257693A contemplate to provide a cut edge with a clear cut and thereby controlling crack initiation or unevenness of the cut surface by feeding the magnetic web with its magnetic layer in contact with the lower blade or by providing the upper blade with a specific chamfer, but do not always provide a sufficiently satisfactory cut surface, still leaving room for further improvements.

In the light of the above mentioned circumstances, it is an object of the present invention to provide a magnetic recording medium having a nonmagnetic support with a Young's modulus of 8 GPa or more in its width direction and excellent in electromagnetic characteristics and cut edge quality and thereby highly reliable in terms of running durability and dropout reduction. Another object of the invention is to provide a process of producing such a magnetic recording medium.

The object of the invention is accomplished by the provision of a magnetic recording medium including, in the order described, a nonmagnetic support having a Young's modulus of 8 GPa or more in its width direction, a nonmagnetic layer formed by radiation curing a dispersion of a radiation curing compound and a nonmagnetic powder in a binder, and a magnetic layer having a ferromagnetic powder dispersed in a binder. The magnetic recording medium has a cut surface along the edge thereof. The cut surface has a waviness (defined later) of 20% to 50%.

The magnetic recording medium of the invention has a nonmagnetic layer and a magnetic layer provided on a nonmagnetic support having a Young's modulus of 8 GPa or more in its width direction. The nonmagnetic layer is formed by radiation curing a dispersion of a radiation curing compound and a nonmagnetic powder in a binder. The magnetic layer is formed of a dispersion of a ferromagnetic powder in a binder. Because the cut surface along the edge of the magnetic recording medium has a waviness of 20% to 50%, the medium exhibits superior electromagnetic characteristics and cut edge quality and is thereby highly reliable in running durability and dropout reduction. The waviness is preferably 20% to 40%, more preferably 20% to 30%. When the waviness is less than 20%, the protrusion of the nonmagnetic support is higher than that of the magnetic layer on the cut surface. As a result, the magnetic recording medium produces an increased amount of debris during running due to scraping of the nonmagnetic support, which can invite an increase of dropouts and the like. If the waviness exceeds 50%, the protrusion of the magnetic layer is higher than that of the support. As a result, the magnetic layer produces an increased amount of debris during running due to scraping, which is deposited on the head, resulting in stop of running in the worst case.

The term “waviness” as used herein is defined to be a percentage of a distance X to the total thickness t of a magnetic recording medium, the distance X being defined to be the distance from a boundary point between the support and the nonmagnetic layer on a cut surface of the magnetic recording medium to a point where a straight line passing the boundary point in parallel to the thickness direction of the magnetic recording medium intersects the cut surface.

The invention provides a preferred embodiment of the magnetic recording medium, in which the magnetic recording medium is a magnetic tape.

The preferred embodiment provides a magnetic tape excellent in electromagnetic characteristics and cut edge quality.

The object of the invention is also accomplished by the provision of a process of producing a magnetic recording medium including, in the order described, a nonmagnetic support having a Young's modulus of 8 GPa or more in its width direction, a nonmagnetic layer formed by radiation curing a dispersion of a radiation curing compound and a nonmagnetic powder in a binder, and a magnetic layer having a ferromagnetic powder dispersed in a binder. The process includes the step of introducing a continuous magnetic recording web between a rotating lower blade and a rotating upper blade to cut the web to width. The lower and upper blades are in sliding contact on their circumferentially facing sides. The rotating upper blade has a chamfered edge width of 0.01 to 0.08 mm.

According to the process of the invention, the waviness of the cut surface is controlled between 20% and 50% so that the resulting magnetic recording medium exhibits excellent electromagnetic characteristics and edge quality.

The present invention provides a magnetic recording medium having a nonmagnetic support with a Young's modulus of 8 GPa or more in its width direction and excellent in electromagnetic characteristics and cut edge quality and thereby highly reliable in terms of running durability and dropout reduction. The invention also provides a process of producing such a magnetic recording medium.

### BRIEF DESCRIPTION OF THE DRAWINGS

FIG. 1 is a fragmental, longitudinal cross-section of an essential part of a slitter for slitting a magnetic recording web.

FIG. 2 is a cross-section of an essential part of a rotating upper blade.

FIG. 3 is an enlarged cross-section of a cut edge of a magnetic recording medium.

FIG. 4 is a perspective of an essential part of a conventional slitter for slitting a magnetic recording web.

### DESCRIPTION OF REFERENCE

21: upper blade
21a: cutting surface
22: lower blade
22a: cutting surface
30: magnetic recording medium (magnetic tape)
30a: cut surface
31: nonmagnetic support
32: nonmagnetic layer
33: magnetic layer
W: chamfered edge width

### DETAILED DESCRIPTION OF THE INVENTION

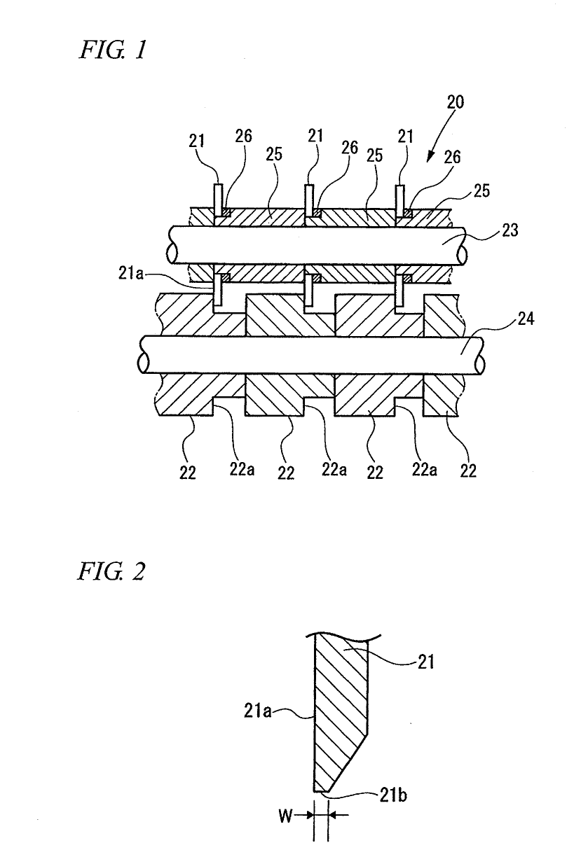

The magnetic recording medium and the process of producing the same according to the invention will be described in detail with reference to their preferred embodiments by way of the accompanying drawing. FIG. 1 is a cross-section of an essential part of a slitter for obtaining a magnetic recording medium. FIG. 2 is a cross-section of an essential part of a rotating upper blade.

The magnetic recording medium (magnetic tape) obtained in the present embodiment has, in the order described, a nonmagnetic support, a nonmagnetic layer formed by radiation curing a dispersion of a radiation curing compound and a nonmagnetic powder in a binder, and a magnetic layer having a ferromagnetic powder dispersed in a binder. The nonmagnetic support has a Young's modulus of 8 GPa or more in its width direction. By using a nonmagnetic support having a Young's modulus of 8 GPa or more, the tape width variation is reduced so that the positional variation of servo signals recorded on, e.g., an LTO drive in the tape width direction is reduced, providing stable running properties. When in using a nonmagnetic support with a Young's modulus less than 8 GPa, the tape width variation increases, which can result in a failure to read servo signals, leading to stop of running. Moreover, a magnetic tape having a nonmagnetic support with a Young's modulus less than 8 GPa in the width direction is susceptible to edge damage, has deteriorated durability, and causes head contamination.

As shown in FIG. 1, the slitter 20 is composed of vertical sets of a rotating upper blade 21 and a rotating lower blade 22. The lower blades 22 are each a hollow circular cylinder made of an ultra hard material, such as tungsten carbide, and are fitted over a rotating shaft 24 at a given interval. The rotating shaft 24 is driven by a motor (not shown). One side (the right hand side in FIG. 1) of each lower blade 22 provides a generally circular cutting surface 22a. The cutting surfaces 22a of the lower blades 22 are arranged in the axial direction of the rotating shaft 24 at the same interval as the prescribed width of the magnetic tape.

The upper blades 21 are each a thin disk made of an ultra hard material, such as tungsten carbide, and are secured around a rotating shaft 23 at a given interval. The rotating shaft 23 is placed parallel to the rotating shaft 24 having the lower blades 22 fitted thereon and driven by a motor. A spacer 25 is fitted in between adjacent upper blades 21 so that the upper blades 21 may be regularly spaced along the axial direction of the rotating shaft 23.

The upper blade 21 is positioned such that its circumferential cutting edge may enter the gap formed between adjacent lower blades 22, that is, the lower cutting edge of the upper blade 21 and the upper cutting edge of the lower blade 22 may overlap each other in their radial directions when viewed from a side. The upper blade 21 is urged in the thrust direction (to the left in FIG. 1) by an elastic member 26, such as a disc spring, and thus prevented from being separated away from the lower blade 22 by the resistance of the magnetic recording web being cut.

As illustrated in FIG. 2, the upper blade 21 has a cutting surface 21a on one side thereof (the left handed side in FIGS. 1 and 2) and an outer peripheral surface 21b. The width W of the outer peripheral surface 21b measured in the thickness direction of the upper blade 21, i.e., the chamfered edge width W of the upper blade 21 is 0.01 to 0.08 mm, preferably 0.01 to 0.05 mm. The cutting surface 21a of the upper blade 21 is in sliding contact with the cutting surface 22a of the lower blade 22a to produce a shear cutting action, whereby the magnetic recording web is slit to width.

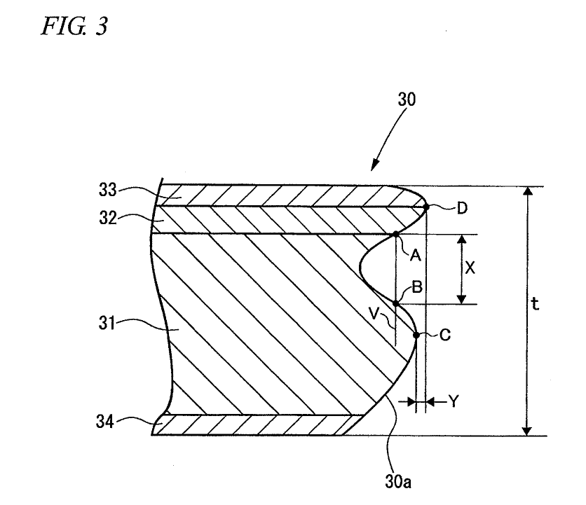

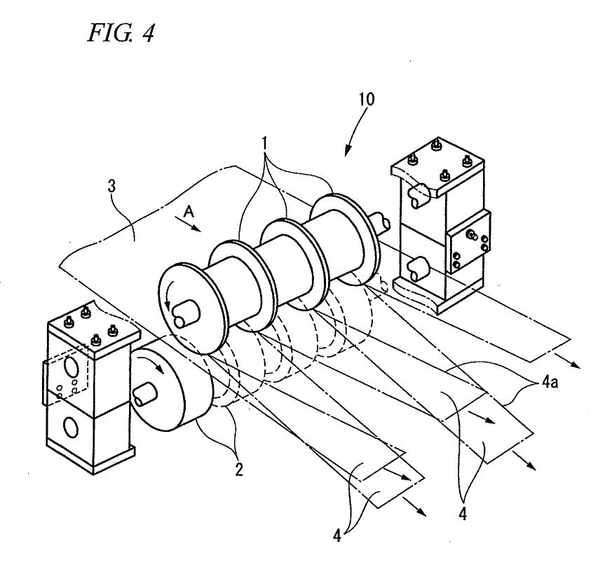

FIG. 3 is an enlarged cross-section of a cut edge of a magnetic recording medium 30. As illustrated, the magnetic recording medium 30 of the invention has a nonmagnetic support 31, a nonmagnetic layer 32 on one side (front side) of the support 31, and a magnetic layer 33 on the nonmagnetic layer 32. The nonmagnetic support 31 may be formed of, e.g., polyethylene terephthalate, polyethylene naphthalate, or polyamide and has a Young's modulus of 8 GPa or more in its width direction.

The nonmagnetic layer is formed by radiation curing a dispersion of a radiation curing compound and a nonmagnetic powder in a binder. The radiation curing compound that can be used in the invention includes a radiation curing compound that comprises a diisocyanate having a branched structure and no ring structure and contains a radiation curing functional group in the molecule thereof. Examples of the nonmagnetic powder include inorganic substances, such as metals, metal oxides, and metal carbonates; organic powders, e.g., of acryl styrene resins, benzoguanamine resins or melamine resins; and carbon black.

The radiation curing compound (a compound having a radiation curing functional group in the molecule and comprising a diisocyanate having a branched structure and no ring structure) will be described in greater detail.

A radiation curing compound starts polymerizing or crosslinking to increase in molecular weight and cure upon being irradiated with radiation, such as ultraviolet light or electron beam radiation. The reaction of a radiation curing compound does not proceed unless provided with activating energy (e.g., ultraviolet light or electron beam radiation) from the outside. In other words, a coating composition containing a radiation curing compound has a stable viscosity to provide a coating film with high smoothness in the absence of ultraviolet radiation or electron beam radiation. The curing reaction proceeds instantaneously on exposure to high energy of ultraviolet or electron beam radiation. Therefore, a coating composition containing a radiation curing compound yields high coating film strength.

Examples of the radiation that can be used in the invention include electron beam (β rays), ultraviolet rays, X rays, γ rays, and α rays.

The radiation curing compound that can be used in the invention is exemplified by urethane acrylate or methacrylate compounds prepared from a diisocyanate having a branched side chain (e.g., a methyl group) as a branched structure and having no ring structure.

Having a branched structure, the radiation curing compound used in the invention is less prone to crystallization than an aliphatic (having no ring structure), straight-chain compound and is effective in reducing the viscosity of a coating composition for a nonmagnetic layer. The coating composition therefore has excellent leveling properties to level off the rough surface of the support. As a result, a magnetic layer formed on the nonmagnetic layer has good surface smoothness and exhibits high electromagnetic characteristics.

To enhance the effect in reducing the viscosity, it is preferred to use a mixture of radiation curing compounds the branched structures of which are isomeric. For example, a radiation curing compound mixture prepared by using a mixture of 2,4,4-trimethylhexamethylene diisocyanate and 2,2,4-trimethylhexamethylene diisocyanate as a diisocyanate as described infra can be used preferably.

The radiation curing compound used in the invention is prepared by, for example, one of the following three processes (1) to (3).

(1) A compound having a group reactive with an isocyanate and a radiation curing functional group in the molecule is caused to react with the diisocyanate.
(2) An NCO-terminated prepolymer obtained by the reaction between the diisocyanate and a diol is caused to react with a compound having a group reactive with the isocyanate (e.g., hydroxyl group) and a radiation curing functional group in its molecule.
(3) An OH-terminated urethane prepolymer obtained by the reaction between the diisocyanate and a diol is caused to react with a compound having an NCO group and a radiation curing functional group in its molecule.

Examples of the diisocyanate that can be used include lysine diisocyanate methyl ester, and trimethylhexamethylene diisocyanates.

Examples of the compound having a group reactive with an isocyanate and a radiation curing functional group in its molecule include 2-isocyanatoethyl acrylate and 2-isocyanatoethyl methacrylate. 2-Isocyanatoethyl acrylate is preferably used for its excellent curing properties.

Examples of the compound having a hydroxyl group and a radiation curing functional group include 2-hydroxyethyl acrylate, 2-hydroxyethyl methacrylate, pentaerythritol triacrylate, dipentaerythritol pentaacrylate, trimethylolpropane diacrylate, ditrimethylolpropane triacrylate, pentaerythritol trimethacrylate, dipentaerythritol pentamethacrylate, trimethylolpropane dimethacrylate, and ditrimethylolpropane trimethacrylate. Preferred of them is 2-hydroxyethyl acrylate.

Any known diol compound may be used to prepare the NCO-terminated or OH-terminated urethane prepolymer. Diols having a branched structure and no ring structure are preferred, including 2,2-dimethyl-1,3-propanediol, 3,3-dimethyl-1,5-pentanediol, 2-methyl-2-ethyl-1,3-propanediol, 3-methyl-3-ethyl-1,5-pentanediol, 2-methyl-2-propyl-1,3-propanediol, 3-methyl-3-propyl-1,5-pentanediol, 2-methyl-2-butyl-1,3-propanediol, 3-methyl-3-butyl-1,5-pentanediol, 2,2-diethyl-1,3-propanediol, 3,3-diethyl-1,5-pentanediol, 2-ethyl-2-butyl-1,3-propanediol, 3-ethyl-3-butyl-1,5-pentanediol, 2-ethyl-2-propyl-1,3-propanediol, 3-ethyl-3-propyl-1,5-pentanediol, 2,2-dibutyl-1,3-propanediol, 3,3-dibutyl-1,5-pentanediol, 2,2-dipropyl-1,3-propanediol, 3,3-dipropyl-1,5-pentanediol, 2-butyl-2-propyl-1,3-propanediol, 3-butyl-3-propyl-1,5-pentanediol, 2-ethyl-1,3-propanediol, 2-propyl-1,3-propanediol, 2-butyl-1,3-propanediol, 3-ethyl-1,5-pentanediol, 3-propyl-1,5-pentanediol, 3-butyl-1,5-pentanediol, 3-octyl-1,5-pentanediol, 3-myristyl-1,5-pentanediol, 3-stearyl-1,5-pentanediol, 2-ethyl-1,6-hexanediol, 2-propyl-1,6-hexanediol, 2-butyl-1,6-hexanediol, 5-ethyl-1,9-nonanediol, 5-propyl-1,9-nonanediol, and 5-butyl-1,9-nonanediol.

Preferred of them are 2-ethyl-2-butyl-1,3-propanediol and 2,2-dimethyl-1,3-propanediol. Polyester polyols prepared from the diols recited are also useful.

The radiation curing compound preferably has a molecular weight of 400 to 5,000. The molecular weight falling within the range, precipitation of an unreacted monomer component on the coating film surface is avoided, and the coating composition has a suitable viscosity to provide sufficient film surface smoothness.

The radiation curing functional group possessed by the radiation curing compound is preferably an acryloyl group. It is preferred for the radiation curing compound to have 2 to 6 radiation curing functional groups per molecule to secure good storage stability and to provide good curing properties.

Having a radiation curing functional group in its molecule, the radiation curing compound exhibits excellent curing properties to provide high crosslinking density. As a result, an unreacted monomer component is prevented from precipitating on the magnetic layer surface in long term storage, whereby deterioration in running durability during long term storage is avoided.

The above-described radiation curing compound may be used in combination with other known radiation curing compound to make the nonmagnetic layer. The other radiation curing compound to be used in combination is preferably selected from those having at least two acryloyl groups per molecule.

Examples of such radiation curing compounds include those having a ring structure, such as 5-ethyl-2-(2-hydroxy-1,1′-dimethylethyl)-5-(hydroxymethyl)-1,3-dioxane diacrylate, tetrahydrofuran dimethanol diacrylate, and 3,9-bis(1,1-dimethyl-2-hydroxyethyl)-2,4,8,10-tetraoxaspiro[5,5]undecane diacrylate; and those having 4 or more acryloyl groups, such as trimethylolpropane ethylene oxide-modified triacrylate, trimethylolpropane propylene oxide-modified triacrylate, dipentaerythritol tetraacrylate, dipentaerythritol pentaacrylate, dipentaerythritol hexaacrylate, and ditrimethylolpropane tetraacrylate.

Particularly preferred of them are aliphatic acrylates having 3 or more acryloyl groups per molecule, such as trimethylolpropane ethylene oxide-modified triacrylate and trimethylolpropane propylene oxide-modified triacrylate.

When combined with the known radiation curing compound, the radiation curing compound according to the present invention is preferably used in a proportion of at least 30% by weight, more preferably 50% by weight or more, relative to the total amount of the radiation curing compounds. Using a radiation curing compound to form the nonmagnetic layer is advantageous in that the surface of the nonmagnetic layer is not attacked by the solvent of a coating composition for making a magnetic layer when the coating composition is applied to the nonmagnetic layer. Should the solvent attack the nonmagnetic layer surface, the resultant disturbed interface between the nonmagnetic layer and the magnetic layer causes deterioration of electromagnetic characteristics.

Examples of the radiation that can be used to form the nonmagnetic layer are electron beam radiation and ultraviolet radiation. In using ultraviolet light, the coating composition must contain a photopolymerization initiator. Electron beam curing is preferred because of no need to use a polymerization initiator and deeper penetration into the coating layer.

An electron accelerator of scanning, double scanning, or curtain beam system may be used to carry out electron beam curing. A curtain type electron accelerator is preferred for obtaining a high output at a relatively low cost. Electron radiation is applied at an acceleration voltage of 30 to 1000 kV, preferably 50 to 300 kV, to an absorption dose of 0.5 to 20 Mrad, preferably 2 to 10 Mrad. With the acceleration voltage being in the range recited, a sufficient amount of energy penetrates, and good energy efficiency is secured.

The atmosphere for electron beam irradiation preferably has an oxygen concentration reduced to 200 ppm or less by purging with nitrogen so as not to hinder crosslinking and curing reaction on and proximate to the surface of the coating layer.

In using ultraviolet radiation, a mercury lamp is preferably used as a light source. In a preferred example, radiation from a mercury lamp of 20 to 240 W/cm is applied to a coated web moving at a speed of 0.3 to 20 m/min. The mercury lamp is generally preferably set 1 to 30 cm distant from the coated material.

A light emitting diode (LED) emitting ultraviolet radiation is also useful. For example, an LED having a light emission peak wavelength of 365 nm may be used.

In the case of ultraviolet curing, a photo radical initiator is used as a photopolymerization initiator. For the details, reference is made to The Society of Polymer Science, Japan (ed.), KOBUNSHI JIKKENGAKU, vol. 2, ch. 6 “HIKAR1 HOUSYASENJYUGO”, Kyoritsu Shuppan (1995). Examples of suitable photo radical initiators are acetophenone, benzophenone, anthraquinone, benzoin ethyl ether, benzyl methyl ketal, benzyl ethyl ketal, benzoin isobutyl ketone, hydroxydimethyl phenyl ketone, 1-hydroxycyclohexyl phenyl ketone, and 2,2-diethoxyacetophenone. The amount of the aromatic ketone (photo radical initiator) to be used is preferably 0.5 to 20 parts, more preferably 2 to 15 parts, even more preferably 3 to 10 parts, by weight per 100 parts by weight of the radiation curing compound.

Apparatus and conditions for radiation curing are conventional. Reference may be made to UV EB KOKA GIJUTU, Sogo Gijutu Center and TEI ENERGY DENSHISEN NO OHYO GIJUTU, CMC Publishing Co., Ltd. (2000).

The magnetic layer 33 is formed of an acicular ferromagnetic powder or a tabular ferromagnetic powder (e.g., ferromagnetic hexagonal ferrite powder) dispersed in a binder, such as a polyurethane resin, an acrylic resin, a cellulosic resin, or a vinyl chloride resin.

The nonmagnetic support 31 has a backcoat layer 34 on the other side (back side) thereof. The backcoat layer 34 is formed by applying a coating composition containing a particulate component, such as an abrasive or an antistatic agent, and a binder dispersed in an organic solvent.

The magnetic recording medium 30 as obtained by slitting a magnetic recording web through the slitter 20 has a cut surface 30a. As illustrated in FIG. 3, the cut surface 30a is uneven, comprising a shear region resulting from a shear action exerted in the initial stage of cutting and a fracture region resulting from a fracture action in the later stage of cutting. The cut surface 30a usually has the edge of the magnetic layer 33 protruding beyond the edge of the nonmagnetic support 31. The difference in height of protrusions between the highest peak C of the nonmagnetic support 31 and the highest peak D of the magnetic layer 33, which will hereinafter be referred to as a base protrusion Y, is desirably as small as possible in terms of electromagnetic conversion and running durability.

When the magnetic recording web is slit with the slitter 20 according to the present embodiment, the upper blade 21 of which slitter has a chamfered edge width W of 0.01 to 0.08 mm, preferably 0.01 to 0.05 mm, the cut surface 30a of the resulting magnetic recording medium (magnetic tape) has a waviness S of 20% to 50%. The waviness S is preferably 20% to 40%, more preferably 20% to 30%.

The term “waviness (S)” as used herein is defined to be a percentage of a distance X to the total thickness t of a magnetic recording medium, the distance X being defined to be the distance from a boundary point A between the nonmagnetic support 31 and the nonmagnetic layer 32 on a cut surface 30a of the magnetic recording medium 30 to a point B where a straight line V passing the boundary point A in parallel to the thickness direction of the magnetic recording medium 30 intersects the cut surface 30a. In short, waviness S=X/t×100(%).

The chamfered edge width W of the upper blade is limited to 0.01 to 0.08 mm for the following reason. If a web is cut with a rotating upper blade with its chamfered edge width W of more than 0.08 mm, a crack is likely to occur on the cut surface 30a. If the chamfered edge width W is less than 0.01 mm, a fracture region increases with the cutting length. In an extreme case, the web can fail to be cut and undergo tearing.

As described, the present invention provides a magnetic recording medium having a nonmagnetic support with a Young's modulus of 8 GPa or more in its width direction and excellent in electromagnetic characteristics and cut edge quality and thereby highly reliable in terms of running durability and dropout reduction.

### EXAMPLES

The present invention will now be illustrated in greater detail with reference to Examples and Comparative Examples. Magnetic recording webs in Examples and Comparative Examples, except Comparative Example 4, were prepared as follows. Unless otherwise noted, all the parts are by weight.

### (1) Synthesis of Radiation Curing Compound

Lysine diisocyanate methyl ester was dissolved in a 70% methyl ethyl ketone solution in a container equipped with a reflux condenser and a stirrer at 60° C. in a nitrogen stream. To the solution were added dibutyltin dilaurate and methoxyhydroquinone in concentrations of 60 ppm and 200 ppm, respectively, relative to the lysine diisocyanate methyl ester, followed by stirring to dissolve for 5 minutes. 2-Hydroxyethyl acrylate was added thereto in an amount of 2 mol per mole of the lysine diisocyanate methyl ester. The mixture was heated at 80° C. for 6 hours to obtain a radiation curing compound solution. The resulting solution was analyzed by FTIR to find no disappearance of acryloyl groups.

### (2) Preparation of Magnetic Coating Composition

A hundred parts of acicular ferromagnetic alloy powder (Hc: 175 kA/m (2200 Oe); BET specific surface area: 70 m²/g; particle size (length): 45 nm; aspect ratio: 4; σs: 125 A·m²/kg (125 emu/g)) was pulverized in an open kneader for 10 minutes. Ten parts (on a solid basis) of an SO₃Na-containing polyurethane solution (solid content: 30%; SO₃Na content: 70 μeq/g; weight average molecular weight: 80,000) and then 30 parts of cyclohexanone were added to the powder, followed by kneading for 60 minutes. To the mixture were further added 2 parts of an α-Al₂O₃ abrasive (particle size: 0.3 μm), 2 parts of carbon black (particle size: 40 μm), and 200 parts of a 1/1 mixed solvent of methyl ethyl ketone (MEK) and toluene, followed by dispersing in a sand mill for 120 minutes. Two parts of butyl stearate, 1 part of stearic acid, and 50 parts of MEK were added thereto, and the mixture was stirred for 20 minutes and filtered through a filter having an average pore size of 1 μm to prepare a magnetic coating composition.

### (3) Preparation of Nonmagnetic Coating Composition A

A hundred parts of α-Fe₂O₃ (average particle size: 0.15 μm; BET specific surface area: 52 m²/g), 20 parts of 2-isocyanatoethyl acrylate (radiation curing compound), and 30 parts of cyclohexanone were kneaded in an open kneader for 60 minutes. Two hundred parts of a 6/4 mixed solvent of MEK and cyclohexanone was added, followed by dispersing in a sand mill for 120 minutes. Two parts of butyl stearate, 1 part of stearic acid, and 50 parts of MEK were added thereto, and the mixture was stirred for 20 minutes and filtered through a filter having an average pore size of 1 μm to prepare a nonmagnetic coating composition A.

### (4) Preparation of Backcoating Composition

### Mixture A:

| | | |
|---|---|---|
| Carbon black A (particle size: 40 nm) | 100 | parts |
| Nitrocellulose RS1/2 | 50 | parts |
| Polyurethane resin (Tg: 50° C.) | 40 | parts |

Dispersant system

| | | |
|---|---|---|
| Copper oleate | 5 | parts |
| Copper phthalocyanine | 5 | parts |
| Precipitated barium sulfate | 5 | parts |
| MEK | 500 | parts |
| Toluene | 500 | parts |

### Mixture B:

| | | |
|---|---|---|
| Carbon black B (specific surface area: 8.5 m²/g; average | 100 | parts |
| particle size: 270 nm; DBP absorption: 36 ml/100 g: | | |
| pH: 10) | | |
| Nitrocellulose RS1/2 | 40 | parts |
| Polyurethane resin | 10 | parts |
| MEK | 300 | parts |
| Toluene | 300 | parts |

Mixture A was preliminarily kneaded in a roll mill. Mixtures A and B were dispersed in a sand grinder. Finally, parts of a polyester resin and 5 parts of a polyisocyanate were added thereto to prepare a coating composition for backcoat layer.

### (5) Preparation of Magnetic Recording Web

The nonmagnetic coating composition was applied to one side of a continuous web of a polyethylene naphthalate support having a thickness of 5.0 μm and a varied Young's modulus in CD as shown in Table 1 below to a dry thickness of 1.4 μm and dried. The coating film was irradiated with electron beam radiation at an acceleration voltage of 125 kV to an absorption dose of 3 Mrad to be cured. The magnetic coating composition A was applied thereto to a dry thickness of 0.1 μm. The magnetic coating layer was magnetically oriented while wet using a cobalt magnet with a magnetic force of 5000 G and a solenoid with a magnetic force of 4000 G and then dried to be free of solvent. The backcoating composition was applied to the other side of the support to a dry thickness of 0.5 μm and dried. The coated web was calendered on a 7-roll calender having metal rolls.

In Comparative Example 4, a magnetic recording web was prepared in the same manner as described above, except for using a nonmagnetic coating composition B prepared as described below to form a lower nonmagnetic layer in place of the radiation cured nonmagnetic layer.

### (6) Preparation of Nonmagnetic Coating Composition B

| | | |
|---|---|---|
| Nonmagnetic powder, hematite (length: 0.10 μm; BET | 80 | parts |
| specific surface area: 52 m²/g; pH: 8.7; tap density: 0.8; | | |
| DBP absorption: 27-37 g/100 g; surface treatment: Al₂O₃ | | |
| and SiO₂) | | |
| Carbon black (average primary particle size: 18 mμ; pH: | 20 | parts |
| 8.0; DBP absorption: 80 ml/100 g; BET specific surface | | |
| area: 250 m²/g) | | |
| Vinyl chloride copolymer MR 110 (from Zeon Corp.) | 17 | parts |
| Polyurethane resin UR8200 (from Toyobo Co., Ltd.) | 5 | parts |
| α-Al₂O₃ (average particle size: 0.2 μm) | 5 | parts |
| Butyl stearate | 1 | part |
| Stearic acid | 1 | part |
| MEK | 50 | parts |

The above components were mixed by stirring for 20 minutes, followed by filtration through a filter having a pore size of 1 μm to prepare a nonmagnetic coating composition B.

### Examples 1 to 4 and Comparative Examples 1 to 7

Each of the magnetic coating webs prepared above was slit into ½ inch wide tapes by a slitter equipped with a rotating upper blade having a varied chamfered edge width W as shown in Table 1.

The resulting magnetic tapes were tested and evaluated as follows.

### (a) Electromagnetic Characteristics

The magnetic tape was wound and assembled into a cartridge of LTO format. The magnetic tape was tested on an LTO-IBM drive to measure reproduced output. The reproduced output of a commercially available LTO cartridge was taken as 0 dB.

### (b) Running Durability

The magnetic tape was run on an LTO-IBM drive up to 300 passes. The number of the pass where running stopped was recorded. The contamination of the drive head after the running was observed with the naked eye.

### (c) Degree of Unevenness of Cut Surface

The cut surface of the magnetic tape was observed under a microscope to measure the thickness t and the distance X defined above, from which a waviness S was calculated. The base protrusion Y defined above was also measured.

The results of the testing and evaluation are shown in Table 1.

TABLE 1

| | Support, | | Chamfered | | | Running | | |
|---|---|---|---|---|---|---|---|---|
| | Young's | Radiation | Edge | | Base | Durability | Head | |
| | Modulus in CD | Cured | Width W | Waviness S | Protrusion Y | (number of | Contami- | Output |
| | (GPa) | Layer | (mm) | (%) | (μm) | passes) | nation | (dB) |
| Example 1 | 8.5 | yes | 0.01 | 20 | 0.15 | >300 | very good | 2.5 |
| Example 2 | 8.0 | yes | 0.05 | 50 | 0.1 | >300 | very good | 2.3 |
| Example 3 | 9.0 | yes | 0.08 | 35 | 0.08 | 300 | good | 2.3 |
| Example 4 | 9.2 | yes | 0.03 | 30 | 0.05 | >300 | very good | 2.9 |
| Comp. Example 1 | 7.0 | yes | 0.005 | 10 | 1 | >200 | bad | 2.0 |
| Comp. Example 2 | 6.5 | yes | 0.1 | 60 | 0.1 | 100 | bad | 2.0 |
| Comp. Example 3 | 6.0 | yes | 0.2 | 80 | 0.1 | 85 | bad | 2.0 |
| Comp. Example 4 | 8.0 | no | 0.05 | 25 | 0.07 | 300 | good | 0.0 |
| Comp. Example 5 | 8.3 | yes | 0.009 | 15 | 0.5 | 100 | bad | 2.5 |
| Comp. Example 6 | 8.3 | yes | 0.15 | 70 | 0.15 | 50 | bad | 2.0 |
| Comp. Example 7 | 7.0 | yes | 0.05 | 35 | 0.15 | 80 | bad | 1.5 |

As shown in Table 1, the magnetic tapes of Examples 1 to 4, in which the upper blade of the slitter had a chamfered edge width W of 0.01 to 0.08 mm, had a satisfactory cut surface profile with a waviness S being in the range of from 20% to 50%. In Examples 1 to 4, the output was 2.3 dB or higher, the running durability was more than 300 passes, and no head contamination was observed after the running durability test.

In Comparative Examples 1 to 3, in which slitting of the web was carried out using an upper blade having a chamfered edge width W of 0.005 mm, 0.1 mm, or 0.2 mm, the magnetic tapes had a waviness S of 10%, 60%, or 80%, respectively, which are out of the range specified in the present invention. In these Comparative Examples, the output was 2.0 dB; the running durability did not reach 300 passes; and head contamination was observed after the running durability test.

In Comparative Example 4, where an upper blade having a chamfered edge width W of 0.05 mm was used, although the magnetic tape exhibited satisfactory results in terms of waviness S (25%), running durability (more than 300 passes), and head contamination after the running durability test, it had an output as small as 0 dB. In Comparative Example 5, since slitting was conducted using an upper blade having a chamfered edge width W of 0.009 mm, the cut surface of the magnetic tape had a waviness S as small as 15%, and the base protrusion Y was as large as 0.5 μm. As a result, head contamination occurred.

In Comparative Example 6, in which an upper blade with a chamfered edge width W of 0.15 mm was used, the cut surface of the magnetic tape had a waviness S as large as 70%, and head contamination occurred. In Comparative Example 7, the waviness S of the cut surface was equal to that in Example 3. However, since the nonmagnetic support had a Young's modulus of less than 8 GPa in the CD, the tape was easily susceptible to edge damage, resulting in poor running durability and head contamination. The effectiveness of the present invention has thus been verified.

While the present invention has been described with reference to its preferred embodiments, it should be understood that the invention is not construed as being limited thereto, and various changes and modifications can be made therein without departing from the spirit and scope thereof.

What is claimed is:

1. A process for producing a magnetic recording medium comprising, in the following order, a nonmagnetic support having a Young's modulus of 8 GPa or more in a width direction, a nonmagnetic layer formed by radiation curing a dispersion of a radiation curing compound and a nonmagnetic powder in a binder, and a magnetic layer comprising a ferromagnetic powder dispersed in a binder,
the process comprising: cutting a continuous magnetic recording web to width by introducing the web between a lower blade and an upper blade both rotating in sliding contact on circumferentially facing sides of the lower and upper blades, the upper blade having a chamfered edge width of from 0.01 to 0.08 mm.
